(19) United States
(12) Patent Application Publication
(10) Pub. No.: US 2011/0133660 A1
(43) Pub. Date: Jun. 9, 2011

(54) LIGHT EMITTING DEVICE, LIGHTING DEVICE, LIGHTING SYSTEM, LIGHT EMITTING DIODE CIRCUIT, MOUNTING SUBSTRATE, AND LIGHT EMITTING METHOD FOR LIGHT EMITTING DIODE

(75) Inventors: Hiroyuki Tomita, Ichihara-shi (JP); Takeo Watanabe, Ichihara-shi (JP)

(73) Assignee: Showa Denko K.K., Tokyo (JP)

(21) Appl. No.: 13/002,830

(22) PCT Filed: Jul. 2, 2009
(86) PCT No.: PCT/JP2009/062094

§ 371 Date: Jan. 6, 2011

(30) Foreign Application Priority Data
Jul. 7, 2008 (JP) 2008-177296
Jul. 11, 2008 (JP) 0228-182049

(51) Int. Cl. H05B 37/02

(52) U.S. Cl. 315/193

(57) ABSTRACT

A lighting system includes: plural light emitting chips (52) each having a blue LED; a substrate (51) on which the plural blue LEDs are connected in a series with polarities thereof aligned, thereby to form a light emitting diode array; a shade (12) to which the substrate (51) is attached, the shade (12) being electrically grounded; an AC-DC conversion device for converting alternating current supplied from an AC power supply through first and second feed lines into direct current and supplying the direct current to the light emitting diode array; a conductive sheet disposed between the substrate (51) and the shade (12), the sheet being electrically insulated from the substrate (51) and the shade (12) and being electrically connected to the first feed line; and a switch for electrically connecting and disconnecting the second feed line.

### TECHNICAL FIELD

The present invention relates to a light emitting device using light emitting diodes, a lighting device, a lighting system including the same, a light emitting diode circuit, a light emitting diode mounting substrate and a light emitting method for light emitting diodes.

### BACKGROUND ART

Recently, there has been proposed a technique in which light emitting diodes (hereinafter, abbreviated as LEDs) expected to have high efficiency and long lifetime are used as a lighting device, instead of a bulb and a fluorescent lamp. Such LEDs have a characteristic of emitting light with a current flowing in a forward direction and of not emitting light with a current flowing in a reverse direction. Additionally, it is known that an LED has lower tolerance to a voltage (reverse voltage) applied in the reverse direction, as compared with a typical rectifying diode.

A typical commercial power supply employs alternating current. Thus, if an LED is directly connected to alternating current, an excessive reverse voltage is periodically applied to the LED, which may lead to a failure in light emission of the LED.

For this reason, there have been proposed various techniques in which alternating current of a commercial power supply or the like is converted into direct current, which is then supplied to LEDs.

As a conventional art described in an official gazette, there is a technique for a light emitting device for an AC power supply that subjects a commercial AC power supply to full-wave rectification by using a diode bridge circuit, for example, and feeds the plural LEDs connected in a series. In this technique, capacitors are connected in parallel to the plural LEDs that are connected in a series, thereby to suppress flicker of each LED, (see Patent Document 1, for example).

Additionally, as a conventional art described in another official gazette, there is a technique for a light emitting diode displaying device that subjects an AC power supply to full-wave rectification by using a diode bridge circuit, for example, and feeds the plural light emitting diodes connected in a series. In this technique, a switch is provided for electrically connecting and disconnecting an AC power supply and the diode bridge circuit, and each of the light emitting diodes are caused to emit light and put out by ON and OFF of the switch (see Patent Document 2, for example).

Patent Document 1: Japanese Patent Application Laid Open Publication No. 2007-12808

Patent Document 2: Japanese Patent Application Laid Open Publication No. 5-66718

### DISCLOSURE OF THE INVENTION

### Problems to be Solved by the Invention

However, in a case where alternating current is converted into direct current to feed an LED, there may occur a phenomenon in which a reverse voltage is applied to the LED while a switch is kept at OFF in order not to cause the LED to emit light, for example.

If such a phenomenon occurs, there may be a possibility that LEDs disposed at the both ends in a connecting direction among plural LEDs connected in a series do not emit light.

An object of the present invention is to suppress application of a reverse voltage to the plural light emitting diodes connected in a series and the attendant occurrence of a failure in light emission of the light emitting diodes.

### Means for Solving the Problems

In order to attain the above object, a lighting system to which the present invention is applied includes: plural light emitting diodes; a substrate on which the plural light emitting diodes are connected in a series with polarities thereof aligned, thereby to form a light emitting diode array; a housing to which the substrate is attached, the housing being electrically grounded; an AC-DC conversion unit for converting alternating current into direct current and supplying the direct current to the light emitting diode array, the alternating current being supplied from an AC power supply through a first feed line and a second feed line; a switch for electrically connecting and disconnecting the second feed line; and a conductive member disposed between the substrate and the housing, the conductive member being electrically insulated from the housing and being electrically connected to any one of portions of an electric circuit located from the first feed line to the switch provided for the second feed line.

In such a lighting system, the conductive member is electrically connected to any one of a portion located from the first feed line to an anode end of the light emitting diode array and a portion located from the switch provided for the second feed line to a cathode end of the light emitting diode array. The conductive member is electrically connected to the first feed line. The conductive member is electrically connected to any one of ends of the light emitting diode array. Moreover, the AC-DC conversion unit is a non-insulated type in which a primary side thereof connected to the AC power supply is not insulated from a secondary side thereof connected to the light emitting diode array. Furthermore, the AC-DC conversion unit is formed of a diode bridge circuit. In this case, the diode bridge circuit includes: two input connecting portions that are respectively connected to the first feed line and the second feed line; and two output connecting portions that are connected to the light emitting diode array, and a capacitor is connected between the two output connecting portions. Additionally, the lighting system further includes insulating members that are respectively provided between the conductive member and the substrate, and the conductive member and the housing. The conductive member is integrated with the substrate.

In another aspect of the present invention, a lighting system to which the present invention is applied includes: plural light emitting diodes; a substrate on which the plural light emitting diodes are connected in a series with polarities thereof aligned, thereby to form a light emitting diode array; a housing to which the substrate is attached, the housing being electrically grounded; an AC-DC conversion unit for converting alternating current into direct current and supplying the direct current to the light emitting diode array, the alternating current being supplied from an AC power supply through a first feed line and a second feed line; a switch for electrically connecting and disconnecting the second feed line; and a conductive member integrated with the substrate and provided so as to face the housing, the conductive member being electrically insulated from the housing and being electrically connected to any one of portions of an electric circuit located from the first feed line to the switch provided for the second feed line.

In such a lighting system, the conductive member is connected to an interconnect provided for the substrate, the interconnect connecting the plural light emitting diodes. The conductive member is electrically connected to any one of ends of the light emitting diode array.

In a further aspect of the present invention, a lighting device to which the present invention is applied includes: plural light emitting diodes; a substrate on which the plural light emitting diodes are connected in a series with polarities thereof aligned, thereby to form a light emitting diode array; a housing to which the substrate is attached, the housing being electrically grounded; and a heat radiation member that is disposed between the substrate and the housing, and transmits heat generated at the plural light emitting diodes to the housing through the substrate. The heat radiation member includes: a first insulating member that has insulation and is provided on a side through which the first insulating member is in contact with the housing; a second insulating member that has insulation and is provided on a side through which the second insulating member is in contact with the substrate; and a conductive member that has electrical conductivity and is provided between the first insulating member and the second insulating member.

In such a lighting device, the light emitting diode array is supplied with direct current obtained by converting alternating current supplied from an AC power supply through a first feed line and a second feed line that is provided with a switch, and the conductive member is electrically connected to the first feed line. The housing also serves as a reflecting member that reflects light emitted from the plural light emitting diodes.

In a still further aspect of the present invention, a light emitting device to which the present invention is applied includes: plural light emitting diodes; a substrate on which the plural light emitting diodes are connected in a series with polarities thereof aligned, thereby to form a light emitting diode array; and a conductive member that is formed, so as to be integrated with the substrate, at the back of a surface of the substrate, the surface having the plural light emitting diodes attached thereto, the conductive member being connected to an interconnect connecting the plural light emitting diodes.

In such a light emitting device, the conductive member is formed substantially all over the substrate. The conductive member is electrically connected to any one of ends of the light emitting diode array. Moreover, the conductive member is formed on a rear surface of the substrate. Furthermore, the substrate includes: a first substrate to which the plural light emitting diodes are attached; and a second substrate disposed so as to face a surface of the first substrate opposite to a surface thereof to which the plural light emitting diodes are attached, and the conductive member is formed between the first substrate and the second substrate.

A light emitting diode circuit to which the present invention is applied includes: a substrate; plural light emitting diodes that are mounted on a surface of the substrate so as to be connected in a series through an interconnect; an AC-DC conversion circuit that feeds a direct current from an anode side of the plural light emitting diodes to a cathode side thereof; a live-side terminal and a neutral-side terminal that supply an alternating voltage to the AC-DC conversion circuit; and a conductive layer that is formed on a back surface side of the surface of the substrate to which the plural light emitting diodes are attached, the conductive layer being connected to any one of the anode side of the plural light emitting diodes and the cathode side thereof. The conductive layer is used to suppress a leakage current flowing from the plural light emitting diodes to a ground side through a stray capacitor.

Here, the conductive layer is formed substantially all over a surface of the substrate at the back of the surface thereof to which the plural light emitting diodes are attached.

Additionally, a power supply of the alternating voltage is a commercial power supply.

A light emitting diode mounting substrate to which the present invention is applied includes: a substrate; plural light emitting diodes that are mounted on a surface of the substrate so as to be connected in a series through an interconnect; a conductive layer that is formed substantially all over a surface of the substrate at the back of the surface thereof to which the plural light emitting diodes are attached; and a connecting member for connecting in a series the conductive layer to any one of an anode side and a cathode side of the plural light emitting diodes. A direct current is fed from the anode side of the plural light emitting diodes to the cathode side thereof.

A light emitting method for light emitting diodes to which the present invention is applied is a light emitting method for light emitting diodes causing plural light emitting diodes to emit light by feeding a direct current obtained by converting an received alternating voltage, the direct current being fed from an anode side of the plural light emitting diodes to a cathode side thereof, the plural light emitting diodes being mounted on a surface of a substrate so as to be connected in a series through an interconnect. The method includes suppressing a leakage current flowing from the plural light emitting diodes to a ground side through a stray capacitor by using a conductive layer that is provided for the substrate at the back of the surface thereof to which the plural light emitting diodes are attached.

### ADVANTAGES OF THE INVENTION

According to the present invention, it is possible to suppress application of a reverse voltage to the plural light emitting diodes connected in a series and the attendant occurrence of a failure in light emission of the light emitting diodes.

### BEST MODES FOR CARRYING OUT THE INVENTION

Hereinafter, exemplary embodiments of the present invention will be described in detail with reference to the accompanying drawings.

### First Exemplary Embodiment

FIG. 1 is a diagram showing an example of an overall configuration of a lighting system to which the first exemplary embodiment is applied.

This lighting system includes: a lighting device 10 used as a street light or an indoor light, for example; a commercial power supply 20 serving as an example of an AC power supply and supplying power of AC 100 V (an effective value) by using a first feed line 21 and a second feed line 22; an AC-DC conversion device 30 serving as an component of a light emitting diode circuit and converting an alternating voltage supplied by the commercial power supply 20 into a direct voltage; and a switch 40 that electrically connects and disconnects the commercial power supply 20 and the AC-DC conversion device 30.

The AC-DC conversion device 30, serving as an example of an AC-DC conversion unit and an AC-DC conversion circuit, includes a diode bridge circuit 35 formed of four diodes, namely, a first diode 31, a second diode 32, a third diode 33 and a fourth diode 34. In the diode bridge circuit 35, a cathode of the first diode 31 is connected to a cathode of the second diode 32, an anode of the second diode 32 is connected to a cathode of the fourth diode 34, an anode of the fourth diode 34 is connected to an anode of the third diode 33, and a cathode of the third diode 33 is connected to an anode of the first diode 31. In the following description, a connecting portion between the anode of the first diode 31 and the cathode of the third diode 33 will be called first input connecting portion 37a, while a connecting portion between the anode of the second diode 32 and the cathode of the fourth diode 34 will be called second input connecting portion 37b. Additionally, a connecting portion between the cathode of the first diode 31 and the cathode of the second diode 32 will be called first output connecting portion 38a, while a connecting portion between the anode of the third diode 33 and the anode of the fourth diode 34 will be called second output connecting portion 38b. In the present exemplary embodiment, the first input connecting portion 37a and the second input connecting portion 37b function as two input connecting portions, while the first output connecting portion 38a and the second output connecting portion 38b function as two output connecting portions.

Additionally, the AC-DC conversion device 30 further includes: two input terminals, namely, a first input terminal 71 and a second input terminal 72; and three output terminals, namely, a first output terminal 73, a second output terminal 74 and a third output terminal 75. The first input terminal 71 is connected to the first feed line 21, and is connected to the first input connecting portion 37a of the diode bridge circuit 35 and the third output terminal 75 through internal wiring. On the other hand, the second input terminal 72 is connected to the second feed line 22, and is connected to the second input connecting portion 37b of the diode bridge circuit 35 through internal wiring. Additionally, the first output terminal 73 is connected to the first output connecting portion 38a of the diode bridge circuit 35 through internal wiring. On the other hand, the second output terminal 74 is connected to the second output connecting portion 38b of the diode bridge circuit 35 through internal wiring.

Moreover, the AC-DC conversion device 30 further includes a capacitor 36 connected to the first output connecting portion 38a and the second output connecting portion 38b of the diode bridge circuit 35. The capacitor 36 is thus connected between the first output terminal 73 and the second output terminal 74. The capacitor 36 is formed of an electrolytic capacitor.

The first output terminal 73, the second output terminal 74 and the third output terminal 75 of the AC-DC conversion device 30 are connected to the lighting device 10 through a first output line 81, a second output line 82 and a third output line 83, respectively.

The AC-DC conversion device 30 converts an input voltage of AC 100 V inputted from the commercial power supply 20 through the first feed line 21 and the second feed line 22 into a direct output voltage without any other processing. For this reason, the AC-DC conversion device 30 does not include a transformer for temporarily converting the AC 100 V into another alternating voltage, and thus is a non-insulated type in which a primary side (a commercial power supply 20 side) thereof is not insulated from a secondary side (a lighting device 10 side) thereof by a transformer or the like. The direct output voltage is supplied to the lighting device 10 with the first output terminal 73 and the second output terminal 74 being a positive electrode and a negative electrode, respectively.

Note that the AC-DC conversion device 30 of a non-insulated type includes all AC-DC conversion devices, except for a device in which a primary side and a secondary side thereof are insulated from each other by being connected to each other with a transformer or the like, for example, and a primary side and a secondary side of a control circuit are also insulated from each other by being connected to each other with a photocoupler or the like, for example.

The switch 40 is formed of a so-called single-pole switch. Among the first feed line 21 and the second feed line 22 that are used for power supply from the commercial power supply 20, the switch 40 connects and disconnects the second input terminal 72 side, namely, the second feed line 22.

FIGS. 2A and 2B are diagrams for explaining an example of a configuration of the lighting device 10. FIG. 2A is a front elevational view of the lighting device 10 seen from a side to be irradiated, while FIG. 2B is a side elevational view of the lighting device 10.

This lighting device 10 includes: a light emitting device 11 including a substrate 51 on which interconnects, through holes and the like are formed and plural light emitting chips 52 attached to the surface of the substrate 51; and a shade 12 having a concave shape in the cross section thereof and formed so that the light emitting device 11 may be attached to the bottom portion of the inside of the concave. Additionally, the lighting device 10 further includes a heat radiation member 13 disposed so as to be sandwiched between the rear surface of the substrate 51 of the light emitting device 11 and the bottom portion of the inside of the concave of the shade 12. The light emitting device 11 and the heat radiation member 13 are attached and fixed to the shade 12 with metallic screws 14. For this reason, screw holes (not shown) are formed in the substrate 51 so as to correspond to positions to which the screws 14 are attached. The lighting device 10 may be provided with a diffusion lens to make light emitted from the light emitting chips 52 uniform, and the like, as necessary.

The substrate 51 is formed of a copper clad epoxy laminate based on glass fabrics (a glass epoxy substrate) or the like, for example, and has a rectangular shape. Interconnects to electrically connect the plural light emitting chips 52 is formed inside of the substrate 51, and a white resist film is formed by coating on the surface of the substrate 51. The interconnects of the substrate 51 is formed so as to leave copper foil having as much area as possible, in order that both of the front and rear surfaces have better heat radiation characteristics. The front and rear surfaces are electrically and thermally continuous with the through holes. Note that a metallic film may be formed by vapor deposition or the like, instead of the white resist film.

The number of the light emitting chips 52 attached to the surface of the substrate 51 is forty-two in total, consisting of three rows in the lateral direction of the substrate 51 and fourteen columns in the longitudinal direction thereof.

Furthermore, the shade 12 serving as a housing and a reflecting member is formed of a metallic plate subjected to a bending process, for example, and has the inside of the concave portion thereof painted white. The shade 12 is electrically grounded when the lighting device 10 is made. Note that a metallic film may be formed by vapor deposition or the like on the inside of the concave portion of the shade 12, instead of the white painted film.

FIGS. 3A and 3B are diagrams for explaining a configuration of the heat radiation member 13. FIG. 3A shows a top view of the heat radiation member 13, while FIG. 3B shows a cross-sectional view of FIG. 3A taken along a line IIIB-IIIB.

The heat radiation member 13 includes: a first heat radiation sheet 131 serving as an example of a first insulating member and provided on a side through which the heat radiation member 13 is in contact with the shade 12 (see FIGS. 2A and 2B); a conductive sheet 132 serving as an example of a conductive member and provided on the first heat radiation sheet 131; and a second heat radiation sheet 133 serving as an example of a second insulating member and provided on the conductive sheet 132 and on a side through which the heat radiation member 13 is in contact with the rear surface of the substrate 51 (see FIGS. 2A and 2B) of the light emitting device 11. That is, the heat radiation member 13 has a configuration in which the conductive sheet 132 is sandwiched between the first heat radiation sheet 131 and the second heat radiation sheet 133. In the present exemplary embodiment, the first heat radiation sheet 131 and the second heat radiation sheet 133 function as an insulating member. The first heat radiation sheet 131 and the second heat radiation sheet 133 are formed of a material having high heat conductivity and high insulation, such as sheet-like heat conductive gel (produced by Taica Corporation, COH-4000, 1 mm thick), for example. On the other hand, the conductive sheet 132 is formed of a material having high heat conductivity and high electrical conductivity, such as copper foil and aluminum foil, for example.

Additionally, the conductive sheet 132 of the heat radiation member 13 is electrically connected to the third output terminal 75 of the AC-DC conversion device 30 through the third output line 83 shown in FIG. 1, when the lighting device 10 shown in FIGS. 2A and 2B is made.

The heat radiation member 13 has two opening holes 130 formed to penetrate at positions diagonally opposite to each other. The two opening holes 130 are formed at positions penetrated by the screws 14 on the occasion of attachment of the light emitting device 11 and the heat radiation member 13 shown in FIGS. 2A and 2B to the shade 12. The diameter of each opening hole 130 is set to be larger than that of each screw 14, so that the screws 14 do not come into contact with the conductive sheet 132 when the light emitting device 11 and the heat radiation member 13 are attached to the shade 12 by using the screws 14. Note that an insulating protective layer may be formed by using resin or the like on an inner wall of each opening hole 130.

By this configuration, the conductive sheet 132 of the heat radiation member 13 is electrically insulated from the screws 14 and the grounded shade 12, thereby to be set in a non-grounded state, when the lighting device 10 shown in FIGS. 2A and 2B is made. On the other hand, the substrate 51 of the light emitting device 11 is grounded through the screws 14 and the shade 12.

FIGS. 4A and 4B are diagrams for explaining a configuration of each light emitting chip 52. FIG. 4A shows a top view of the light emitting chip 52, while FIG. 4B shows a cross-sectional view of FIG. 4A taken along a line IVB-IVB.

This light emitting chip 52 includes: a housing 61 having a concave portion 61a formed on one side thereof; a first lead portion 62 and a second lead portion 63 that consist of a lead frame formed on the housing 61; a blue LED 66 attached to the bottom of the concave portion 61a; and a sealing portion 69 provided so as to cover the concave portion 61a. In FIG. 4A, illustration of the sealing portion 69 is omitted.

The housing 61 is formed by injection molding of white thermoplastic resin to a metallic lead portion including the first lead portion 62 and the second lead portion 63.

The first lead portion 62 and the second lead portion 63 are a metallic plate having a thickness of about 0.1 to 0.5 mm, and are formed by stacking several •m of nickel, titanium, gold, silver or the like as a plated layer on a base made of an alloy of iron and copper, for example, as metals having excellent formability and heat conductivity.

In the present exemplary embodiment, a part of the first lead portion 62 and the second lead portion 63 is exposed to the bottom of the concave portion 61a. Additionally, one edge portion side of the first lead portion 62 and the second lead portion 63 is exposed to the outside of the housing 61, and is bent from an outer wall of the housing 61 to the rear surface side thereof.

In the metallic lead portion, the second lead portion 63 extends to a center portion of the bottom, while the first lead portion 62 extends to a region on the bottom but not in the center portion thereof. The rear surface side of the blue LED 66 is fixed to the second lead portion 63 with unillustrated paste for die bonding. Additionally, the first lead portion 62 and an anode electrode (not shown) provided for the top face of the blue LED 66 are electrically connected with a gold wire. On the other hand, the second lead portion 63 and a cathode electrode (not shown) provided for the top face of the blue LED 66 are electrically connected with a gold wire.

A light emitting layer of the blue LED 66 serving as an example of a light emitting diode includes GaN (gallium nitride), and emits blue light. Through the blue LED 66 used in the present exemplary embodiment, a forward current I_{F} of 20 mA flows when a forward voltage V_{F} of +3.2 V is applied under the environment of 25 degrees C. The absolute maximum rating of a reverse voltage V_{R} of the blue LED 66 is −5.0 V.

The sealing portion 69 is formed of transparent resin having a high light transmittance for a wavelength in a visible region and having a high refractive index. The sealing portion 69 has a flat surface on the front surface side thereof. For example, epoxy resin or silicone resin can be used as resin having characteristics of high heat resistance, weather resistance and mechanical strength for forming the sealing portion 69. In the present exemplary embodiment, transparent resin forming the sealing portion 69 contains a phosphor converting a part of blue light emitted from the blue LED 66 into green light and red light. Note that, instead of such a phosphor, the transparent resin may contain a phosphor converting a part of the blue light into yellow light or a phosphor converting a part of the blue light into yellow light and red light.

FIG. 5 is a diagram for explaining an example of a circuit configuration in the light emitting device 11.

The light emitting device 11 has the forty-two light emitting chips 52, as described above. In the following description, the forty-two light emitting chips 52 will be called first light emitting chip 52_1 to forty-second light emitting chip 52_42.

Additionally, the light emitting device 11 includes two electrodes for supplying power, namely, a first electrode 54 and a second electrode 55. The first light emitting chip 52_1 to the forty-second light emitting chip 52_42 are connected in a series in numerical order from the first electrode 54 to the second electrode 55. The first light emitting chip 52_1 to the forty-second light emitting chip 52_42 are sequentially connected with the polarities thereof aligned so that each anode included in each of the blue LEDs 66, namely, the first lead portion 62 (see FIGS. 4A and 4B) is on the first electrode 54 side and each cathode, namely, the second lead portion 63 is on the second electrode 55 side. Thus, in the light emitting device 11, the forty-two blue LEDs 66 in total functioning as a light emitting diode array are connected in a series in one direction. Note that a current limitation resistance, a current regulative diode (CRD), a transistor circuit using a transistor or the like may be connected in a series between the first electrode 54 and the second electrode 55, as necessary.

The first electrode 54 is electrically connected to the first output terminal 73 of the AC-DC conversion device 30 through the first output line 81 shown in FIG. 1, while the second electrode 55 is electrically connected to the second output terminal 74 of the AC-DC conversion device 30 through the second output line 82 shown in FIG. 1.

Now, a description will be given of operations of the lighting system shown in FIG. 1, with reference to FIGS. 1 to 5 described above.

First, the second feed line 22 is brought into conduction by turning on the switch 40, to make the commercial power supply 20 and the AC-DC conversion device 30 electrically connected to each other. Thereby, the commercial power supply 20 supplies AC 100 V to the AC-DC conversion device 30 through the first feed line 21 (the first input terminal 71) and the second feed line 22 (the second input terminal 72).

Next, the diode bridge circuit 35 of the AC-DC conversion device 30 subjects, to full-wave rectification, the AC 100 V supplied through the first input connecting portion 37a (the first input terminal 71) and the second input connecting portion 37b (the second input terminal 72), thereby to convert the AC 100 V into a direct current, and outputs the direct current through the first output connecting portion 38a and the second output connecting portion 38b. However, since output from the diode bridge circuit 35 is a pulsating current having a large ripple, the AC-DC conversion device 30 smoothes the pulsating current with the capacitor 36 and outputs the smoothed current from the first output terminal 73 and the second output terminal 74 to the lighting device 10. Full-wave rectification of AC 100 V gives a converted direct voltage of DC 141 V (a theoretical value).

The light emitting device 11 of the lighting device 10 is supplied with DC 141 V by using the first electrode 54 connected to the first output terminal 73 through the first output line 81 as a positive electrode and the second electrode 55 connected to the second output terminal 74 through the second output line 82 as a negative electrode. The DC 141 V is then applied to the first light emitting chip 52_1 to the forty-second light emitting chip 52_42 connected in a series to the first electrode 54 and the second electrode 55, and the direct forward current I_{F} flows in the direction from the first light emitting chip 52_1 to the forty-second light emitting chip 52_42. As a result, the blue LEDs 66 respectively provided for the first light emitting chip 52_1 to the forty-second light emitting chip 52_42 emit blue light. In the first light emitting chip 52_1 to the forty-second light emitting chip 52_42, the phosphors existing in the respective sealing portions 69 then convert a part of the blue light emitted from the respective blue LEDs 66 into green and red. As a result, white light including blue light, green light and red light is emitted from the respective sealing portions 69 of the first light emitting chip 52_1 to the forty-second light emitting chip 52_42. The white light emitted from the first light emitting chip 52_1 to the forty-second light emitting chip 52_42 is projected toward space or an object, directly or after reflection by the substrate 51 or the shade 12.

Meanwhile, heat generated at the blue LEDs 66 of the respective light emitting chips 52 along with light emission is conducted to the front surface of the substrate 51 through the second lead portions 63 to which the respective blue LEDs 66 are attached, and is further conducted to the rear surface of the substrate 51 through the through holes (not shown) formed to penetrate the substrate 51. The heat conducted to the rear surface of the substrate 51 is then conducted to the shade 12 through the heat radiation member 13, namely, the second heat radiation sheet 133, the conductive sheet 132 and the first heat radiation sheet 131, and is released to the outside.

After that, turning off the switch 40 brings the second feed line 22 into a nonconductive state, and thus the blue LEDs 66 are put out in all of the light emitting chips 52 forming the light emitting device 11 of the lighting device 10.

In this example, the forward current I_{F} of 20 mA is fed through the forty-two blue LEDs 66 connected in a series during the light emitting operation. Thus, the whole light emitting device 11 has a voltage drop of 3.2 V×42=134.4 V between the first electrode 54 and the second electrode 55. That is, the amount of the voltage drop occurring in the whole light emitting device 11 is nearly equal to the DC 141 V supplied from the AC-DC conversion device 30. For this reason, this lighting system does not need a transformer for stepping up or down the AC 100 V supplied from the commercial power supply 20 in the AC-DC conversion device 30 before the AC-DC conversion.

The commercial power supply 20 typically used in Japan, for example, namely, a power supply of AC 100 V of a single-phase two-wire system is supplied through the following procedure in general. First, an alternating voltage supplied at a high voltage (6600 V or the like) by using a power transmission line is converted into AC 200 V of a single-phase three-wire system including a grounded potential by a pole transformer or by transformation equipment installed indoor or outdoor, and is then provided for offices and ordinary households. This AC 200 V of the single-phase three-wire system is separated into two lines of AC 100 V of the single-phase two-wire system through a midpoint, and is then supplied to various electric and electronic devices, such as the above-described lighting device 10 and the like. Among two lines of the AC power supply of the single-phase two-wire system, one is grounded at the transformation equipment as a neutral line (a neutral side), and the other is supplied with the AC 100 V as a live wire (a live side). On this occasion, the neutral side constantly maintains a potential of nearly 0 V, while the live side exhibits behavior in which the potential thereof varies like a sinusoidal wave with ±141 V as a peak value.

In the lighting system of the present exemplary embodiment, the switch 40 is formed of a so-called single-pole switch as shown in FIG. 1. In general, it is preferable that the switch 40 be connected to the live side of the commercial power supply 20. However, the switch 40 may be connected to the neutral side in some cases.

Now, suppose a condition that the switch 40 is connected to the neutral side of the commercial power supply 20 and is set at OFF in the lighting system shown in FIG. 1. A description will be given of behavior of the AC-DC conversion device 30 and the lighting device 10 under this condition.

FIG. 6A shows an equivalent circuit of the lighting system in a case where the switch 40 is connected to the neutral side of the commercial power supply 20 and is set at OFF. The second input terminal 72 (see FIG. 1) of the AC-DC conversion device 30 is left open under such a condition. Thus, existence of the second diode 32 and the fourth diode 34, which form the diode bridge circuit 35 shown in FIG. 1, can be ignored in the equivalent circuit.

Additionally, in the lighting device 10 used in the present exemplary embodiment, the heat radiation member 13 including the conductive sheet 132 is provided between the shade 12 and the substrate 51 of the light emitting device 11, while the shade 12 is grounded. For this reason, there are stray capacitors between the conductive sheet 132 and the first light emitting chip 52_1 to the forty-second light emitting chip 52_42 (the blue LEDs 66) on the substrate 51. In the following description, the stray capacitors existing between the conductive sheet 132 and each of the blue LEDs 66 forming the first light emitting chip 52_1 to the forty-second light emitting chip 52_42 will be called first stray capacitor C1 to forty-third stray capacitor C43, respectively. Similarly, there is a stray capacitor (not shown) between the conductive sheet 132 and the shade 12.

FIG. 6B shows the potential of the first input terminal 71 (the first input connecting portion 37a of the diode bridge circuit 35) in the equivalent circuit shown in FIG. 6A. In the case where the switch 40 is connected to the neutral side of the commercial power supply 20, an alternating voltage of ±141 V is applied to the first input terminal 71 at a period corresponding to the frequency of the commercial power supply 20, even if the switch 40 is set at OFF. Thus, the potential of the first input connecting portion 37a connected to the first input terminal 71 periodically varies in a range of ±141 V.

FIG. 6C shows the potential of the conductive sheet 132 of the heat radiation member 13 in the equivalent circuit shown in FIG. 6A. The conductive sheet 132 is connected to the first input connecting portion 37a through the third output terminal 75 of the AC-DC conversion device 30 as described above. Thus, the potential of the conductive sheet 132 is synchronized with that of the first input connecting portion 37a shown in FIG. 6B, and periodically varies in a range of ±141 V.

Accordingly, the difference between the potential of each light emitting chip 52 (each blue LED 66) on the substrate 51 and that of the conductive sheet 132 is nearly equal to 0 at any timing. Thus, in the lighting device 10 of the present exemplary embodiment, a leakage current hardly flows from the substrate 51 side to the conductive sheet 132 through the first stray capacitor C1 to the forty-third stray capacitor C43.

Now, for comparison, a description will be given of behavior of the AC-DC conversion device 30 and the lighting device 10, in a case where the lighting device 10 is formed by using the heat radiation member 13 that does not include the conductive sheet 132, in the lighting system shown in FIG. 1.

FIG. 7A shows an equivalent circuit of the lighting system under the condition similar to that of FIG. 6A, in the above-described configuration. Thus, similarly to FIG. 6A, existence of the second diode 32 and the fourth diode 34, which form the diode bridge circuit 35 shown in FIG. 1, can be ignored in the equivalent circuit.

In the lighting device 10 using the heat radiation member 13 that does not include the conductive sheet 132, there are stray capacitors between the shade 12 and the first light emitting chip 52_1 to the forty-second light emitting chip 52_42 (the blue LEDs 66) on the substrate 51 due to absence of the conductive sheet 132. In the following description, the stray capacitors existing between the shade 12 and each of the blue LEDs 66 forming the first light emitting chip 52_1 to the forty-second light emitting chip 52_42 will be called first stray capacitor C1′ to forty-third stray capacitor C43′, respectively.

FIG. 7B shows the potential of the first input terminal 71 (the first input connecting portion 37a of the diode bridge circuit 35) in the equivalent circuit shown in FIG. 7A. In the case where the switch 40 is connected to the neutral side of the commercial power supply 20, an alternating voltage of ±141 V is applied to the first input terminal 71 at a period corresponding to the frequency of the commercial power supply 20, even if the switch 40 is set at OFF, as in the case described by using FIG. 6B. Thus, the potential of the first input connecting portion 37a connected to the first input terminal 71 periodically varies in a range of ±141 V.

FIG. 7C shows the potential of the shade 12 in the equivalent circuit shown in FIG. 7A. Since the shade 12 is grounded, the potential of the shade 12 is always nearly 0 V.

Accordingly, there is a potential difference between the shade 12 and each light emitting chip 52 (each blue LED 66) on the substrate 51. Thus, in the lighting device 10 using the heat radiation member 13 that does not include the conductive sheet 132, a leakage current flows between the shade 12 and the substrate 51 through the first stray capacitor C1′ to the forty-third stray capacitor C43′.

That is, a positive potential (during a period T1) shown in FIG. 7B feeds a charging current from the substrate 51 to the first stray capacitor C1′ to the forty-third stray capacitor C43′, and in contrast, a negative potential (during a period T2) feeds a discharging current in the reverse direction. Note that because of the effect that there is a phase difference between a voltage and a current applied to the capacity component, the effect that each light emitting chip 52 itself has capacitance (junction capacitance), and the like, there is a difference in phase between the voltage in T1 or T2 shown in FIG. 7B and the charging/discharging current of the first stray capacitor C1′ to the forty-third stray capacitor C43′, which do not necessarily coincide temporally.

Once a current flows between the substrate 51 and the shade 12 as described above, a current flows through the light emitting chips 52, too.

In a typical light emitting diode, occurrence of a definite voltage drop is found even in a case where a minute current flows threrethrough. For example, in a typical blue LED, a voltage drop more than 2 V occurs even with a minute current of about 1 •A.

When the positive potential (during the period T1) shown in FIG. 7B feeds a charging current from the substrate 51 to the first stray capacitor C1′ to the forty-third stray capacitor C43′, a current flows in the forward direction through most of the light emitting chips 52, thereby to generate a potential difference between the positive and negative electrodes of each light emitting chip 52. Thus, among the light emitting chips 52, the light emitting chip 52_1 located closest to the positive electrode has the highest potential, and the potential decreases toward the negative electrode side.

Meanwhile, the positive electrode side of the first diode 31 and the negative electrode side of the third diode 33, which are rectifying diodes, have the same potential, and this potential is the highest. Thus, in an electric circuit from the first diode 31 through the light emitting chip 52_1 to the forty-second light emitting chip 52_42 up to the third diode 33, a certain place has the lowest potential and a reverse voltage is applied to the blue LEDs 66 placed on the negative electrode side with respect to this place.

Similarly, even in the case where the negative potential (during the period T2) shown in FIG. 7B feeds a discharging current from the substrate 51 to the first stray capacitor C1′ to the forty-third stray capacitor C43′, a certain place in the above-described circuit has the lowest potential and a reverse voltage is applied to the blue LEDs 66 placed on the positive electrode side with respect to this place.

As described above, the lighting device 10 using the heat radiation member 13 that does not include the conductive sheet 132 has such a configuration that a reverse voltage is applied to the blue LEDs 66 having low tolerance to a reverse voltage, which leads to concern for decreasing endurance of the blue LEDs 66.

Although the conductive sheet 132 is connected to the first feed line 21 in the present exemplary embodiment, the configuration is not limited to this.

For example, the conductive sheet 132 may be connected to the first input connecting portion 37a, the second input connecting portion 37b, the first output connecting portion 38a or the second output connecting portion 38b of the diode bridge circuit 35 provided for the AC-DC conversion device 30. Instead, for example, the conductive sheet 132 may be connected to the first output terminal 73 or the second output terminal 74 provided for the AC-DC conversion device 30.

Furthermore, even in such a configuration that the conductive sheet 132 is connected to any one of the forty-two light emitting chips 52 provided for the light emitting device 11, the same advantage as in the case where the conductive sheet 132 is connected to the first feed line 21 may be obtained. Although the connecting region of the conductive sheet 132 may be appropriately set, it is preferable that the conductive sheet 132 be connected to either end of the light emitting diode array, namely, the anode side of the blue LED 66 forming the first light emitting chip 52_1 or the cathode side of the blue LED 66 forming the forty-second light emitting chip 52_42. If a configuration in which the light emitting diode array and the conductive sheet 132 are connected to each other is employed, the configuration is realized with interconnects in the lighting device 10 and thus the device configuration may be simplified.

### Second Exemplary Embodiment

FIG. 8 is a diagram showing an example of an overall configuration of a lighting system to which the second exemplary embodiment is applied.

Although the basic configuration of this lighting system is substantially similar to that described in the first exemplary embodiment, the second exemplary embodiment is different from the first exemplary embodiment in that the AC-DC conversion device 30 does not include the third output terminal 75. Although the basic configuration of the lighting device 10 is also substantially similar to that described in the first exemplary embodiment, the second exemplary embodiment is different from the first exemplary embodiment in that the heat radiation member 13 (see FIGS. 3A and 3B) does not include the conductive sheet 132 and is formed of a heat radiation sheet made of sheet-like heat conductive gel, for example. In the second exemplary embodiment, the same reference numerals will be applied to the same components as those in the first exemplary embodiment, and a detailed description thereof will be omitted.

FIGS. 9A to 9C are diagrams showing a configuration of the light emitting device 11 used in the lighting device 10 of the present exemplary embodiment. FIG. 9A shows a top view of the light emitting device 11, while FIG. 9B shows a side elevational view of the light emitting device 11.

The light emitting device 11 functioning as a light emitting diode mounting substrate includes the rectangular substrate 51, and the forty-two light emitting chips 52 arrayed on the front surface side of the substrate 51, similarly to the first exemplary embodiment. Additionally, a conductive layer 53 serving as an example of a conductive member is formed on the rear surface of the substrate 51, namely, at the back of the surface of the substrate 51 to which the plural light emitting chips 52 are attached, substantially all over the rear surface except for regions where opening holes for the screws 14 are formed. The conductive layer 53 is formed of copper foil stuck on the substrate 51, and is integrated with the substrate 51. The conductive layer 53 is electrically connected, through unillustrated through holes and the like, to interconnects (not shown) that is formed in the substrate 51 and that connects the light emitting chips 52. Although the connecting region between the conductive layer 53 and interconnects provided for the substrate 51 may be appropriately set, it is preferable that the conductive layer 53 be connected between the first electrode 54 and the first light emitting chip 52_1 (see FIG. 5) or between the second electrode 55 and the forty-second light emitting chip 52_42 (see FIG. 5), which are provided for the substrate 51. Additionally, the conductive layer 53 is insulated from the shade 12.

In the present exemplary embodiment, the conductive layer 53 is formed on the rear surface of the substrate 51, and is connected to the live side of the commercial power supply 20. Thereby, a leakage current hardly flows from the substrate 51 to the conductive layer 53 through an unillustrated stray capacitor. Similarly to the first exemplary embodiment, this can prevent or minimize the possibility of a trouble in which a reverse voltage is applied to the first light emitting chip 52_1 to the forty-second light emitting chip 52_42, while the switch 40 is set at OFF.

Although the conductive layer 53 is formed on the rear surface of the substrate 51 in the present exemplary embodiment, the configuration is not limited to this. It is only necessary that the conductive layer 53 is formed at the back of the surface of the substrate 51 to which the plural light emitting chips 52 are attached. FIG. 9C is another side elevational view of the light emitting device 11 to which the present exemplary embodiment is applied. That is, as shown in FIG. 9C, the substrate 51 may be formed of a first substrate 51a on which the light emitting chips 52 are mounted and a second substrate 51b provided on the back surface side of the first substrate 51a, for example; and the conductive layer 53 may be sandwiched between the first substrate 51a and the second substrate 51b.

Although a description has been given of an example in which the light emitting device 11 is used to form the lighting device 10 in the first and second exemplary embodiments, the invention is not limited to this. The above-described light emitting device 11 can also be applied to a backlight device, such as a traffic light and a liquid crystal display; a light source device of a scanner; an exposure device of a printer; an in-vehicle lighting device; an LED display using an LED dot matrix; and the like.

Although a description has been given of an example in which one blue

LED 66 is mounted on one light emitting chip 52 in the first and second exemplary embodiments, the configuration is not limited to this. The number of the blue LEDs 66 mounted on one blue LED 66 may be chosen from single or plural and changed in design as appropriate.

Although a description has been given by taking an example of the light emitting chip 52 having the blue LED 66 mounted thereon in the first and second exemplary embodiments, the configuration is not limited to this. For example, an ultraviolet LED, a green LED, a red LED or an infrared LED may be mounted on the light emitting chip 52. Instead, plural LEDs having different colors from each other may be mounted thereon.

Although all of the forty-two light emitting chips 52 are connected in a series in the first and second exemplary embodiments, the configuration is not limited to this. A part of the light emitting chips 52 may be connected in parallel.

Although the AC-DC conversion device 30 subjects alternating current to full-wave rectification by using the diode bridge circuit 35 in the first and second exemplary embodiments, the configuration is not limited to this. For example, alternating current may be subjected to half-wave rectification by using two diodes.

Although the AC-DC conversion device 30 formed only of the diode bridge circuit 35 and the capacitor 36 is used in the first and second exemplary embodiments, the configuration is not limited to this. A circuit for stabilizing currents, such as a current limitation resistance, a constant voltage circuit or a constant current circuit, may be mounted.

Note that, the present invention is not limited to the above-described exemplary embodiments, but may be carried out with various modifications applied thereto within the gist of the invention.

### BRIEF DESCRIPTION OF THE DRAWINGS

FIG. 1 is a diagram showing an example of an overall configuration of a lighting system to which the first exemplary embodiment is applied;

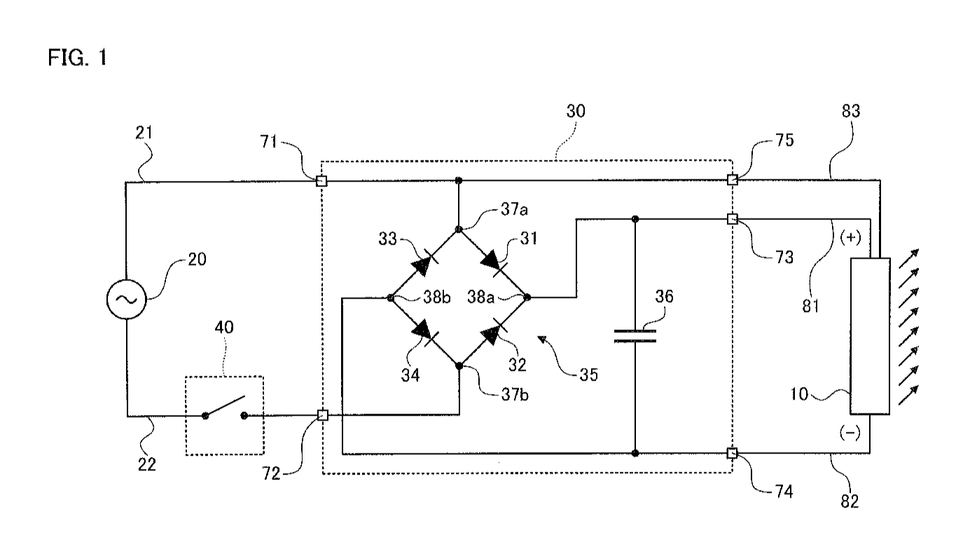

FIGS. 2A and 2B are diagrams for explaining an example of a configuration of the lighting device;

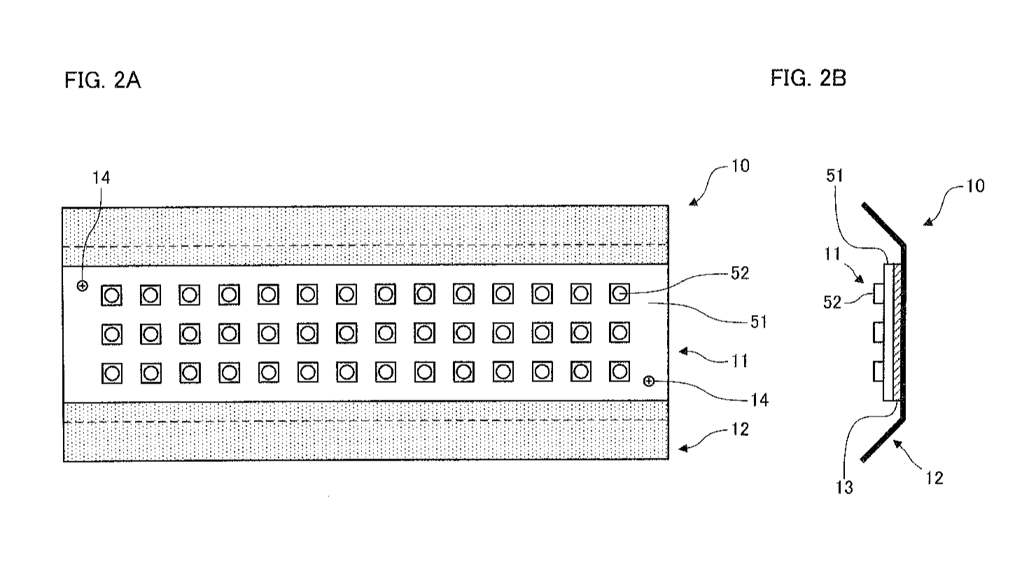

FIGS. 3A and 3B are diagrams for explaining an example of a configuration of the heat radiation member;

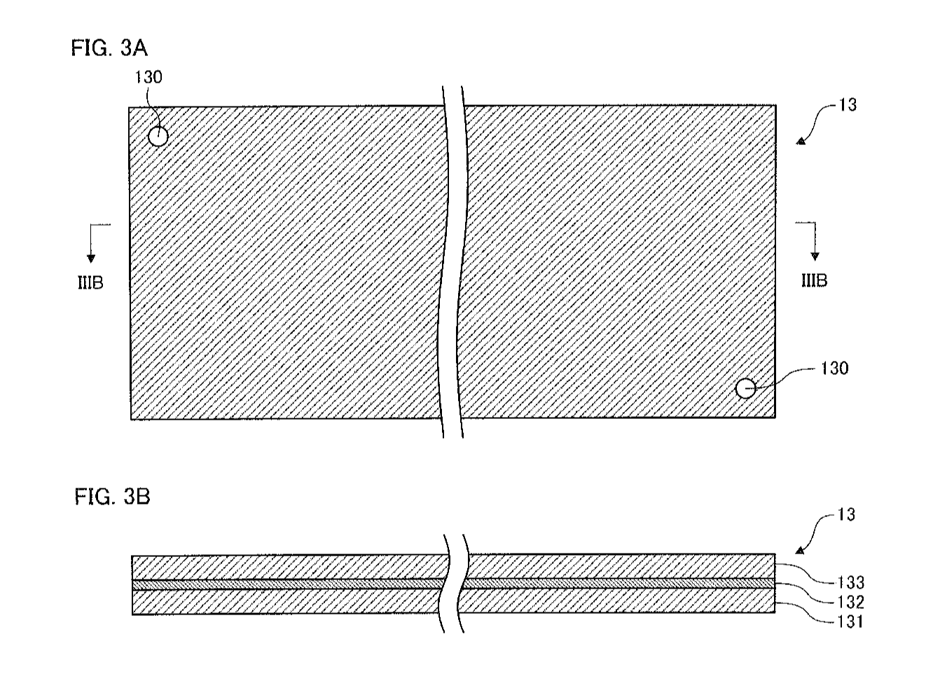

FIG. 4A is a top view of the light emitting chip, while FIG. 4B is a cross-sectional view of FIG. 4A taken along a line IVB-IVB;

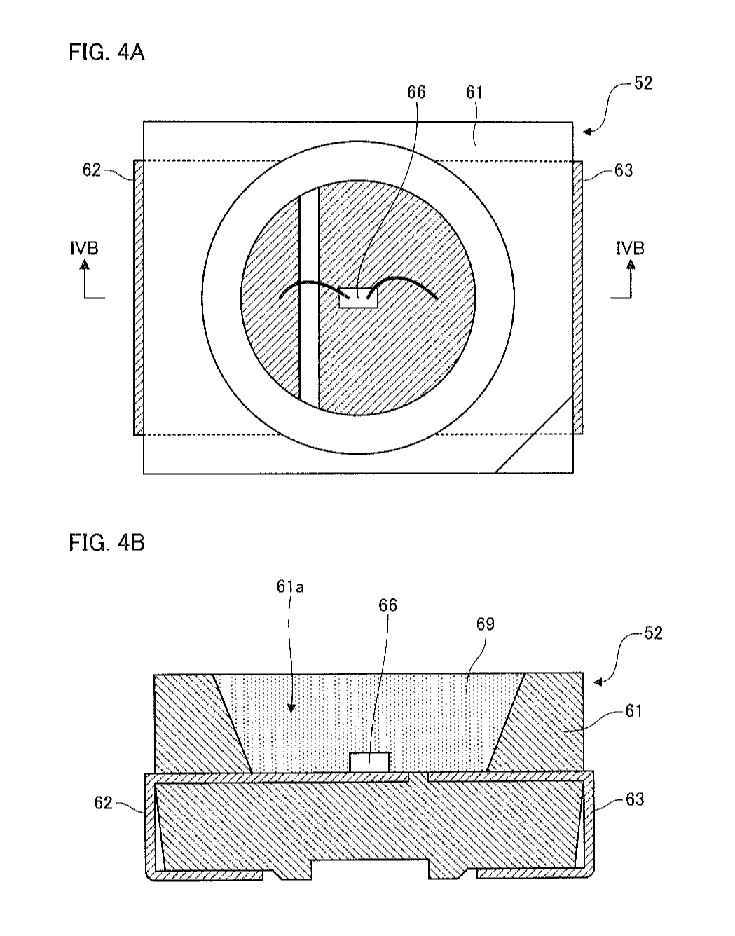

FIG. 5 is a diagram for explaining an example of a circuit configuration in the light emitting device;

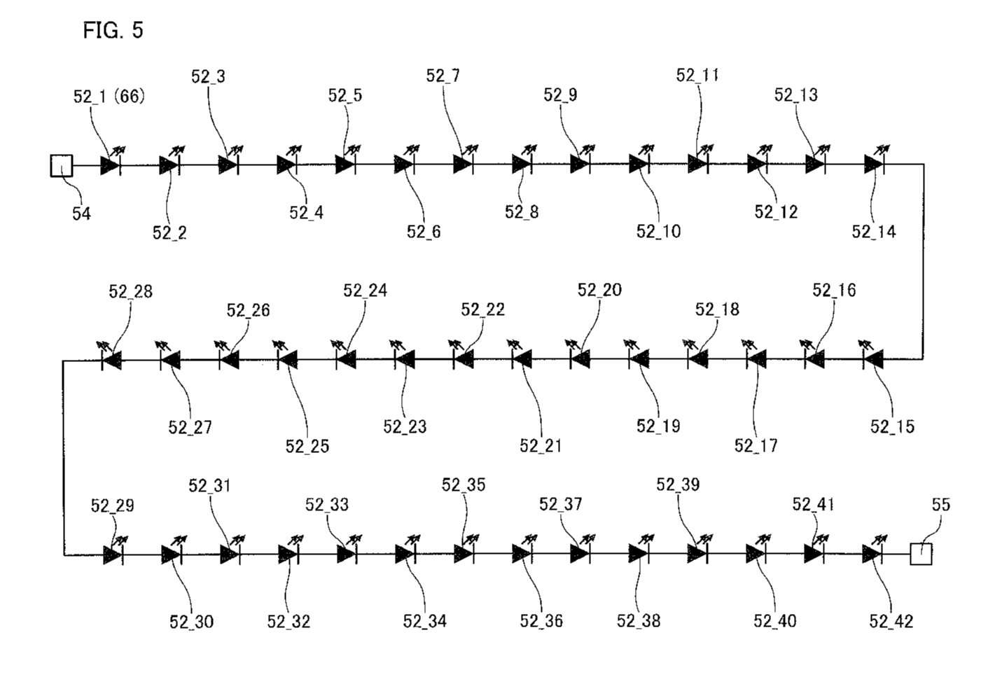

FIGS. 6A to 6C are diagrams showing an equivalent circuit of the lighting system according to the first exemplary embodiment;

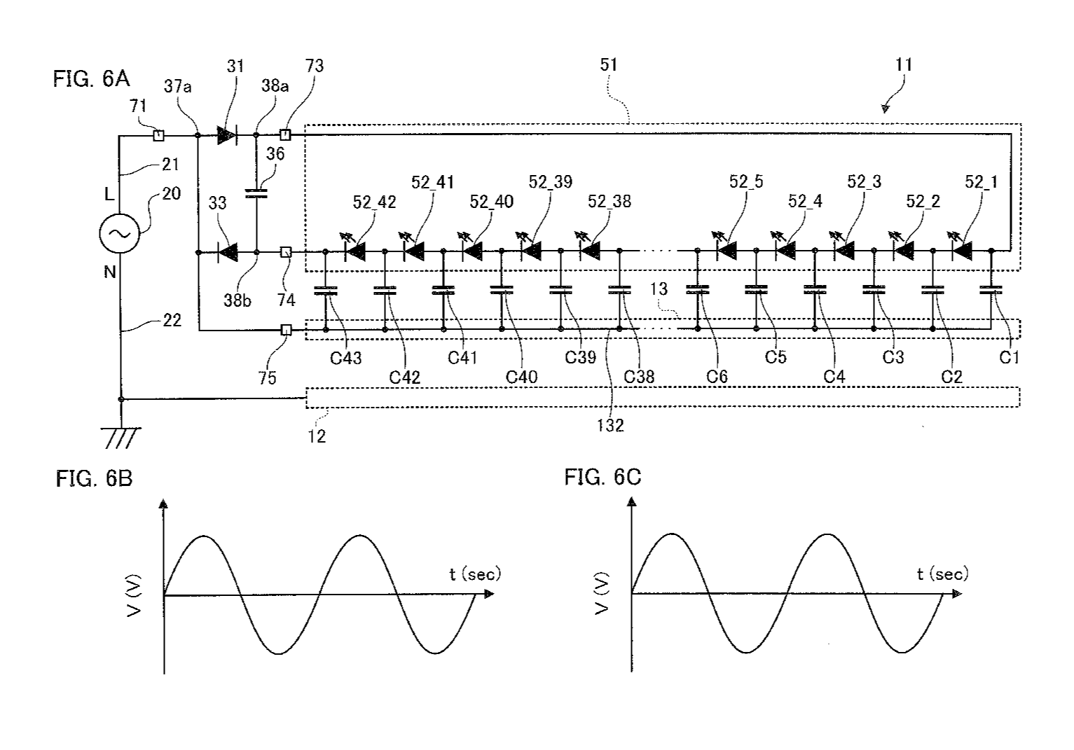

FIGS. 7A to 7C are diagrams showing an equivalent circuit of the lighting system for comparison;

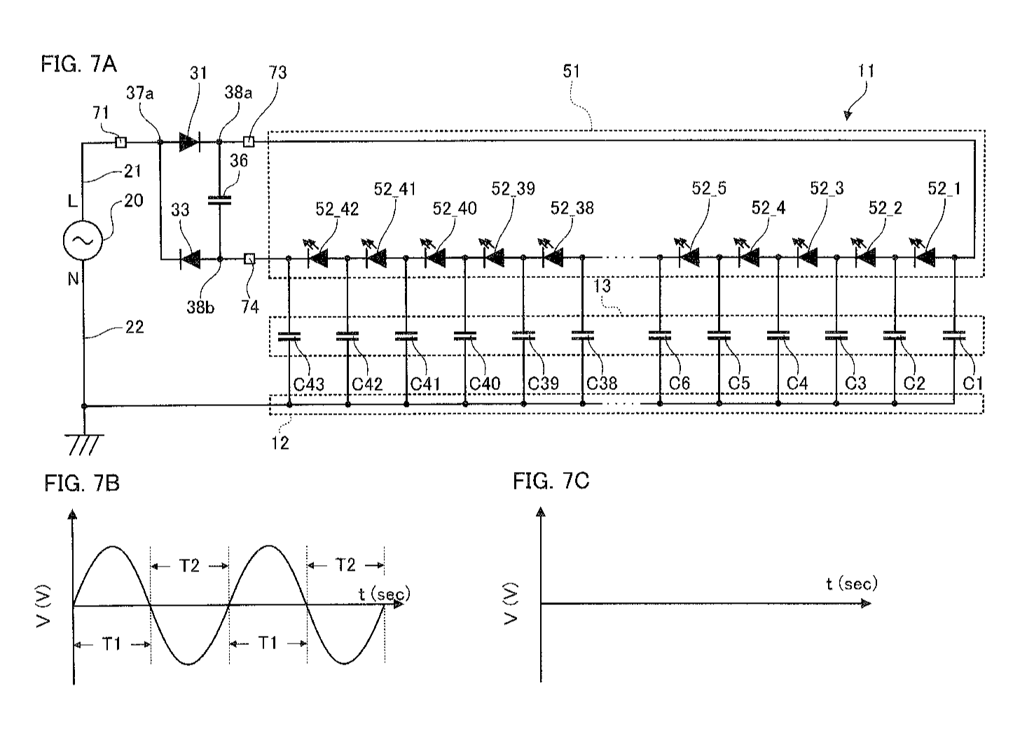

FIG. 8 is a diagram showing an example of an overall configuration of a lighting system to which the second exemplary embodiment is applied; and

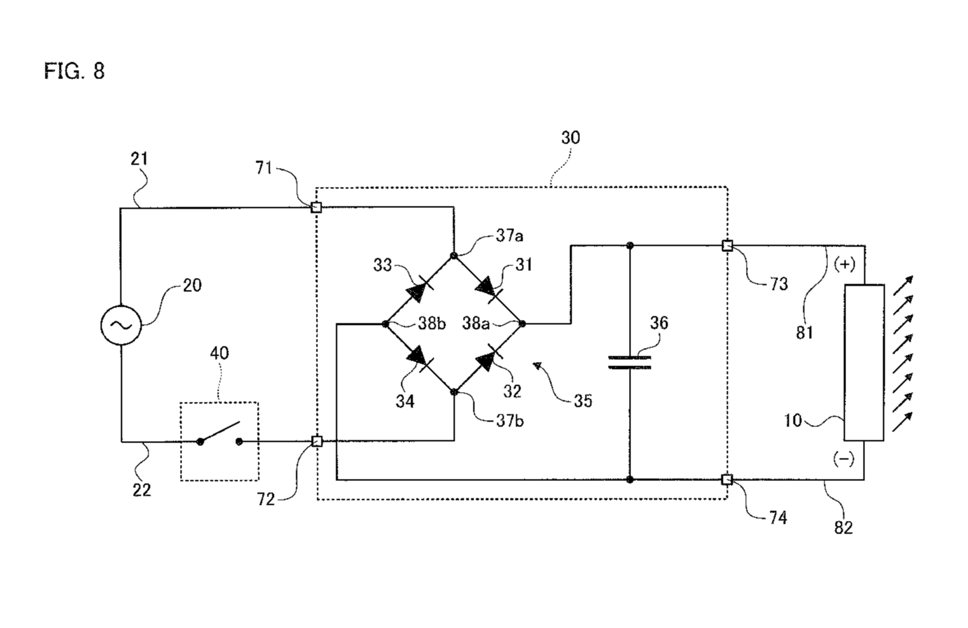

FIG. 9A is a top view of the light emitting device, FIG. 9B is a side elevational view of the light emitting device, and FIG. 9C is a side elevational view of another example of the light emitting device.

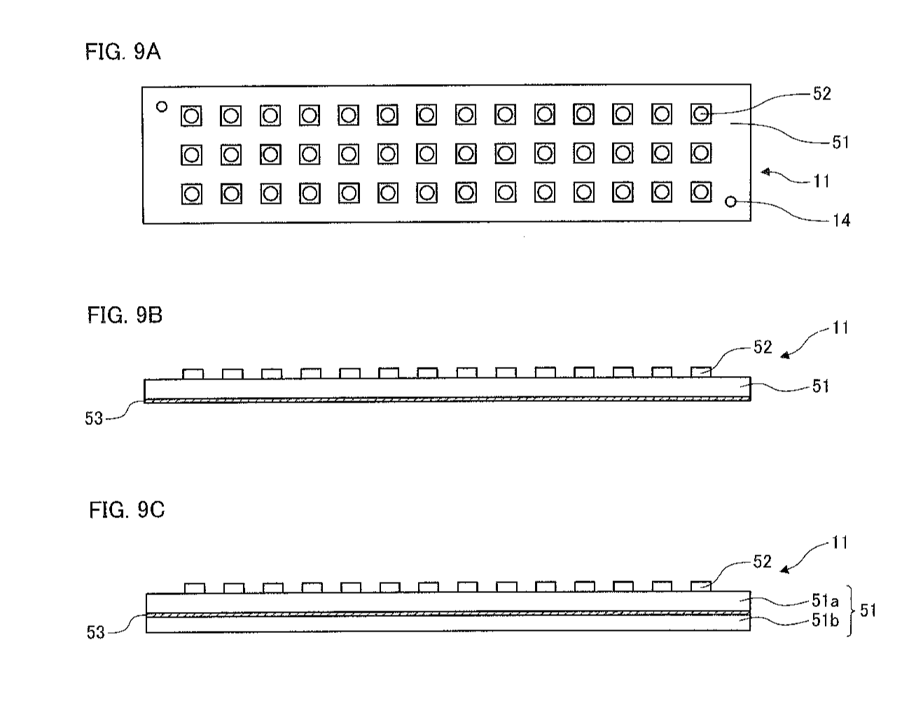

### DESCRIPTION OF REFERENCE NUMERALS AND SIGNS

10 . . . lighting device

11 . . . light emitting device

12 . . . shade

13 . . . heat radiation member

14 . . . screw

20 . . . commercial power supply

30 . . . AC-DC conversion device

31 . . . first diode

32 . . . second diode

33 . . . third diode

34 . . . fourth diode

35 . . . diode bridge circuit

36 . . . capacitor

40 . . . switch

51 . . . substrate

51a . . . first substrate

51b . . . second substrate

52 . . . light emitting chip

53 . . . conductive layer

61 . . . housing

66 . . . blue LED

69 . . . sealing portion

131 . . . first heat radiation sheet

132 . . . conductive sheet

133 . . . second heat radiation sheet

1. A lighting system comprising:
a plurality of light emitting diodes;
a substrate on which the plurality of light emitting diodes are connected in a series with polarities thereof aligned, thereby to form a light emitting diode array;
a housing to which the substrate is attached, the housing being electrically grounded;
an AC-DC conversion unit for converting alternating current into direct current and supplying the direct current to the light emitting diode array, the alternating current being supplied from an AC power supply through a first feed line and a second feed line;
a switch for electrically connecting and disconnecting the second feed line; and
a conductive member disposed between the substrate and the housing, the conductive member being electrically insulated from the housing and being electrically connected to any one of portions of an electric circuit located from the first feed line to the switch provided for the second feed line.

2. The lighting system according to claim 1, wherein the conductive member is electrically connected to any one of a portion located from the first feed line to an anode end of the light emitting diode array and a portion located from the switch provided for the second feed line to a cathode end of the light emitting diode array.

3. The lighting system according to claim 1, wherein the conductive member is electrically connected to the first feed line.

4. The lighting system according to claim 1, wherein the conductive member is electrically connected to any one of ends of the light emitting diode array.

5. The lighting system according to claim 1, wherein the AC-DC conversion unit is a non-insulated type in which a primary side thereof connected to the AC power supply is not insulated from a secondary side thereof connected to the light emitting diode array.

6. The lighting system according to claim 1, wherein the AC-DC conversion unit is formed of a diode bridge circuit.

7. The lighting system according to claim 6, wherein
the diode bridge circuit includes: two input connecting portions that are respectively connected to the first feed line and the second feed line; and two output connecting portions that are connected to the light emitting diode array, and
a capacitor is connected between the two output connecting portions.

8. The lighting system according to claim 1, further comprising insulating members that are respectively provided between the conductive member and the substrate, and the conductive member and the housing.

9. The lighting system according to claim 1, wherein the conductive member is integrated with the substrate.

10. A lighting system comprising:
a plurality of light emitting diodes;
a substrate on which the plurality of light emitting diodes are connected in a series with polarities thereof aligned, thereby to form a light emitting diode array;
a housing to which the substrate is attached, the housing being electrically grounded;
an AC-DC conversion unit for converting alternating current into direct current and supplying the direct current to the light emitting diode array, the alternating current being supplied from an AC power supply through a first feed line and a second feed line;
a switch for electrically connecting and disconnecting the second feed line; and
a conductive member integrated with the substrate and provided so as to face the housing, the conductive member being electrically insulated from the housing and being electrically connected to any one of portions of an electric circuit located from the first feed line to the switch provided for the second feed line.

11. The lighting system according to claim 10, wherein the conductive member is connected to an interconnect provided for the substrate, the interconnect connecting the plurality of light emitting diodes.

12. The lighting system according to claim 10, wherein the conductive member is electrically connected to any one of ends of the light emitting diode array.

13. A lighting device comprising:
a plurality of light emitting diodes;
a substrate on which the plurality of light emitting diodes are connected in a series with polarities thereof aligned, thereby to form a light emitting diode array;
a housing to which the substrate is attached, the housing being electrically grounded; and
a heat radiation member that is disposed between the substrate and the housing, and transmits heat generated at the plurality of light emitting diodes to the housing through the substrate, wherein
the heat radiation member includes:
a first insulating member that has insulation and is provided on a side through which the first insulating member is in contact with the housing;
a second insulating member that has insulation and is provided on a side through which the second insulating member is in contact with the substrate; and
a conductive member that has electrical conductivity and is provided between the first insulating member and the second insulating member.

14. The lighting device according to claim 13, wherein
the light emitting diode array is supplied with direct current obtained by converting alternating current supplied from an AC power supply through a first feed line and a second feed line that is provided with a switch, and
the conductive member is electrically connected to the first feed line.

15. The lighting device according to claim 13, wherein the housing also serves as a reflecting member that reflects light emitted from the plurality of light emitting diodes.

16. A light emitting device comprising:
a plurality of light emitting diodes;
a substrate on which the plurality of light emitting diodes are connected in a series with polarities thereof aligned, thereby to form a light emitting diode array; and
a conductive member that is formed, so as to be integrated with the substrate, at the back of a surface of the substrate, the surface having the plurality of light emitting diodes attached thereto, the conductive member being connected to an interconnect connecting the plurality of light emitting diodes.

17. The light emitting device according to claim 16, wherein the conductive member is formed substantially all over the substrate.

18. The light emitting device according to claim 16, wherein the conductive member is electrically connected to any one of ends of the light emitting diode array.

19. The light emitting device according to claim 16, wherein the conductive member is formed on a rear surface of the substrate.

20. The light emitting device according to claim 16, wherein the substrate includes:
a first substrate to which the plurality of light emitting diodes are attached; and
a second substrate disposed so as to face a surface of the first substrate opposite to a surface thereof to which the plurality of light emitting diodes are attached, and
the conductive member is formed between the first substrate and the second substrate.

21. A light emitting diode circuit comprising:
a substrate;
a plurality of light emitting diodes that are mounted on a surface of the substrate so as to be connected in a series through an interconnect;
an AC-DC conversion circuit that feeds a direct current from an anode side of the plurality of light emitting diodes to a cathode side thereof;
a live-side terminal and a neutral-side terminal that supply an alternating voltage to the AC-DC conversion circuit; and
a conductive layer that is formed on a back surface side of the surface of the substrate to which the plurality of light emitting diodes are attached, the conductive layer being connected to any one of the anode side of the plurality of light emitting diodes and the cathode side thereof, wherein
the conductive layer is used to suppress a leakage current flowing from the plurality of light emitting diodes to a ground side through a stray capacitor.

22. The light emitting diode circuit according to claim 21, wherein the conductive layer is formed substantially all over a surface of the substrate at the back of the surface thereof to which the plurality of light emitting diodes are attached.

23. The light emitting diode circuit according to claim 21, wherein a power supply of the alternating voltage is a commercial power supply.

24. A light emitting diode mounting substrate comprising:
a substrate;
a plurality of light emitting diodes that are mounted on a surface of the substrate so as to be connected in a series through an interconnect;
a conductive layer that is formed substantially all over a surface of the substrate at the back of the surface thereof to which the plurality of light emitting diodes are attached; and
a connecting member for connecting in a series the conductive layer to any one of an anode side and a cathode side of the plurality of light emitting diodes, wherein
a direct current is fed from the anode side of the plurality of light emitting diodes to the cathode side thereof.

25. A light emitting method for light emitting diodes causing a plurality of light emitting diodes to emit light by feeding a direct current obtained by converting an received alternating voltage, the direct current being fed from an anode side of the plurality of light emitting diodes to a cathode side thereof, the plurality of light emitting diodes being mounted on a surface of a substrate so as to be connected in a series through an interconnect,
the method comprising suppressing a leakage current flowing from the plurality of light emitting diodes to a ground side through a stray capacitor by using a conductive layer that is provided for the substrate at the back of the surface thereof to which the plurality of light emitting diodes are attached.
